(19) United States
(12) Patent Application Publication
(10) Pub. No.: US 2026/0070044 A1
(43) Pub. Date: Mar. 12, 2026

(54) CARBON MONOXIDE CATALYST AND PREPARATION METHOD THEREFOR AND USE THEREOF

(71) Applicant: UNIVERSITY OF SCIENCE AND TECHNOLOGY BEIJING, Beijing (CN)

(72) Inventors: Ziyi Li, Beijing (CN); Zixuan Shi, Beijing (CN)

(21) Appl. No.: 19/394,236

(22) Filed: Nov. 19, 2025

Related U.S. Application Data
(63) Continuation of application No. PCT/CN2025/080281, filed on Mar. 3, 2025.

(30) Foreign Application Priority Data
Mar. 4, 2024 (CN) 202410238969.6

(51) Int. Cl. B01J 23/89; B01D 53/86; B01J 21/14; B01J 27/20; B01J 35/31; B01J 35/45; B01J 37/00

(52) U.S. Cl. CPC B01J 23/8993; B01D 53/864; B01J 21/14; B01J 27/20; B01J 35/31; B01J 35/45; B01J 37/0036; B01J 37/0045; B01J 37/0072; B01D 2257/502

(57) ABSTRACT

The present disclosure belongs to the field of catalysts, and in particular relates to a carbon monoxide catalyst and a preparation method therefor and use thereof. The carbon monoxide catalyst includes a support and metal catalytic particles; or metal catalytic particles and metal oxide catalytic particles supported in the support; metals in the metal catalytic particles or the metal oxide catalytic particles include a noble metal, titanium, cerium, cobalt, nickel and molybdenum. The carbon monoxide catalyst provided in the example of the present disclosure can also be used for the catalysis of other combustible gases such as methane, ethanol, hydrogen, and low volatile organic compounds.

### CROSS-REFERENCE TO RELATED APPLICATIONS

This application is a continuation of International Patent Application PCT/CN2025/080281, filed Mar. 3, 2025, which claims priority to China Patent Application 202410238969.6, filed Mar. 4, 2024. International Patent Application PCT/CN2025/080281 and China Patent Application 202410238969.6 are incorporated herein by reference.

### FIELD OF THE INVENTION

The present disclosure belongs to the field of catalysts, and in particular relates to a carbon monoxide catalyst and a preparation method therefor and use thereof.

### BACKGROUND OF THE INVENTION

CO is one of the most widely distributed and abundant pollutants in the atmosphere, with important hazards to the environment and human health. In order to assess air quality, an air quality index (AQI) was introduced in 2012, wherein six main pollutants such as fine particulate matters, inhalable particulate matters, sulphur dioxide, nitrogen dioxide, ozone and carbon monoxide are considered as important reference indicators. Starting from Jan. 1, 2018, the “Environmental Protection Tax Act of People's Republic of China” came into effect, incorporating CO emissions in exhaust gases into the scope of taxation. Therefore, reducing CO emissions has become an important issue of concern. The two major sources of pollution in industrial activities are the steel industry and mobile sources, respectively. Nowadays, mobile source pollution treatment has developed a relatively mature CO removal technology and rich engineering practice experience, and has also achieved good results. However, as a main source of CO emissions, the steel industry does not have a relatively mature catalytic oxidation technology for CO removal. Currently, the two major sources of pollution in industrial activities are the steel industry and mobile sources. There have been a mature CO removal technology and rich engineering practice experience in dealing with mobile source pollution, and significant results have been achieved. However, as one of the main sources of CO emissions, the steel industry lacks a mature catalytic oxidation technology for CO removal.

In the steel industry, a sintering process and a coking process are two main steps in which CO is produced, with the largest emissions in the sintering process. Practical tests have shown that the CO content in sintering flue gas can be as high as 6000-10000 ppm, far exceeding the emissions of SO₂ and NOx. Therefore, purifying CO in the sintering flue gas is the most effective way to reduce CO emissions in the steel industry. Currently, end treatment technologies for treating CO in sintering flue gas in steel enterprises mainly include a direct combustion method, a cryogenic separation method, a solution absorption method, an adsorption method and an oxidation method, etc. Except the oxidation method, other technologies have some problems such as high initiation temperature, difficulty in direct combustion, inability to effectively separate CO from N₂, and high treatment cost and high energy consumption. The oxidation method is based on a principle of promoting the conversion of CO to CO₂ by reacting CO with O₂ in flue gas. The oxidation method has advantages such as high purification efficiency, low operating temperature, safe use and easy operation, and is thus widely acclaimed. Catalysts widely used to purify CO in this stage are mainly noble metal catalysts and non-noble metal catalysts. CO catalysts containing noble metals have certain water resistance, excellent catalytic activity and stability, but are expensive; and a non-noble metal CO catalyst is mainly a hopcalite, and the catalyst consists of a transition metal, is a multi-component metal oxide system, and has the advantages of high purification efficiency, long service life, wide application scenarios, safe use, convenient operation, low cost, etc. However, there is still a trace amount of SO₂ residue after the sintering flue gas is desulfurized, and the residual SO₂ will cause sulfur poisoning of the catalyst, resulting in a decrease in purification efficiency. Its regeneration requires a high-temperature environment, which greatly increases the cost.

### SUMMARY OF THE INVENTION

In order to solve the above problems, the present disclosure proposes a carbon monoxide catalyst and a preparation method thereof and use thereof. The carbon monoxide catalyst is used for purifying carbon monoxide in industrial actual sintering flue gas. The carbon monoxide catalyst has advantages such as sulfur resistance and water resistance. The method adjusts active components of the carbon monoxide catalyst to promote the synergistic effect of the components, and the prepared carbon monoxide catalyst has stable catalytic properties and prolonged service life. Due to high stability of the selected support and metal to an acid, the carbon monoxide catalyst has high sulfur resistance and water resistance, resulting in high catalytic stability in sintering flue gas purification. The carbon monoxide catalyst provided in an example of the present disclosure has a catalytic principle of promoting a redox reaction of a target gas. Therefore, the carbon monoxide catalyst provided in the example of the present disclosure can also be used for the catalysis of other combustible gases such as methane, ethanol, hydrogen, and low volatile organic compounds.

The present disclosure is achieved by the following technical solutions:
a first object of the present disclosure is to provide a carbon monoxide catalyst, including a support and metallic catalytic particles; or metal catalytic particles and metal oxide catalytic particles supported in the support, wherein
metals in the metal catalytic particles or the metal oxide catalytic particles include a noble metal, titanium, cerium, cobalt, nickel and molybdenum.

According to the carbon monoxide catalyst provided in the first object of the present disclosure, the support is used to support metal particles to increase the surface area and active sites of the catalyst; and both the metal catalytic particles and the metal oxide catalytic particles are used to catalyze the generation of environmentally friendly compounds from carbon monoxide. The noble metal is used to reduce the activation energy of carbon monoxide oxidation, playing a catalytic oxidation role; the titanium is used to increase the stability of noble metal catalysis; and the cerium, cobalt, nickel, and molybdenum are used to increase the resistance of noble metals to poisoning. Due to high stability of the selected support and metal to an acid, the carbon monoxide catalyst has high sulfur resistance and water resistance, resulting in high catalytic stability in sintering flue gas purification. The carbon monoxide catalyst has high activity and an applicable temperature range, and catalytic oxidation starts at 120° C. and the catalytic efficiency at 220° C. can reach 90% or more.

Further, the carbon monoxide catalyst has a particle size in the range of 50-200 nm. In this particle size range, the carbon monoxide catalyst can catalytically purify CO with resistance to poisoning in sintering flue gas; and the carbon monoxide catalyst having a nanometer size is not easily agglomerated during the catalytic process while having high adsorption capacity for carbon monoxide due to the use of the support.

Further, a supporting amount of the metal catalytic particles is 90-150 kg/m³. In this range of the metal supporting amount, the carbon monoxide catalyst has high adsorption capacity for carbon monoxide and is also less prone to agglomeration during the catalysis process.

Further, a supporting amount of the metal oxide catalytic particles is 90-150 kg/m³. In this range of the metal supporting amount, the carbon monoxide catalyst has high adsorption capacity for carbon monoxide and is also less prone to agglomeration during the catalysis process.

Further, the metal catalytic particles have a particle size in the range of 1-100 nm. In this particle size range, the size of the metal catalytic particles can be controlled at a nanometer level so that the metal catalytic particles can be highly uniformly dispersed on the support, and thus the metal catalytic particles can be well supported on the support, and the obtained catalyst can maintain stable high catalytic efficiency under the complicated condition of sintering flue gas.

Further, the metal oxide catalytic particles have a particle size in the range of 1-100 nm. In this particle size range, the size of the metal oxide catalytic particles is in a nanometer scale so that the metal oxide catalytic particles can be highly uniformly dispersed on the support, and thus the metal oxide catalytic particles can be well supported on the support, and the obtained catalyst can maintain stable high catalytic efficiency under the complicated condition of sintering flue gas.

Further, the noble metal includes one or more of gold, silver, ruthenium, rhodium, palladium, osmium, iridium, and platinum. These noble metals are active components for catalyzing carbon monoxide and can effectively catalyze carbon monoxide.

Further, the support includes one or more of cordierite, honeycomb ceramic, glass fiber, a porous carbon material, and a hierarchical porous carbon material.

Further, the carbon monoxide catalyst includes the following metal elements in percentage by mass: 0.5-1.0% the noble metal, 0.5-1.0% titanium, 0.5-1.0% cerium, 0.5-1.0% cobalt, 0.5-1.0% nickel, and 0.5-1.0% molybdenum.

A second object of the present disclosure is to provide a preparation method for a carbon monoxide catalyst, including the steps of:
preparing a first powder by using a first noble metal salt solution, a cerium nitrate solution, and a first titanium dioxide suspension;
preparing a second powder by using a first cobalt salt solution, a first metal ammonium salt solution, and a first carbonate solution;
preparing an aqueous catalytic particle solution by using the first powder and the second powder; and
preparing the carbon monoxide catalyst by using the aqueous catalytic particle solution, a first binder solution, a first thickener solution, a first dispersant solution, and a water retaining agent.

In the preparation method for the carbon monoxide catalyst provided in the second object of the present disclosure, the aqueous catalytic particle solution is first prepared, then the aqueous catalytic particle solution is prepared into a first supported slurry, and the carbon monoxide catalyst is prepared from the first supported slurry and a first support. The aqueous catalytic particle solution is prepared first, which can reduce a molecular spacing between catalytically active components (metal catalytic particles and metal oxide catalytic particles) and provide more active sites for catalysis under the same conditions; moreover, a supporting amount of the first support can be reduced under the premise of the same catalytic effect, and the catalytically active components can be uniformly distributed on the support, finally enabling the carbon monoxide catalyst to have a larger specific surface area and supporting strength; and the aqueous catalytic particle solution is prepared into the first supported slurry, and the first supported slurry is subjected to first supporting with the first support, followed by roasting to support the catalytic particles on the first support.

Metal elements in the catalytic particles prepared by the preparation method for the carbon monoxide catalyst provided in the second object of the present disclosure include a noble metal element, a cerium element and a titanium element.

Further, the step of preparing the first powder includes: subjecting the first noble metal salt solution, the cerium nitrate solution and the first titanium dioxide suspension to first mixing to obtain a first mixed solution; and subjecting the first mixed solution to first drying and first roasting to obtain the first powder. In this case, the first powder is prepared and a molecular spacing between catalytically active components (metal catalytic particles and metal oxide catalytic particles) in the first powder is reduced.

Further, a noble metal salt in the first noble metal salt solution includes one or more of a nitrate, chlorate, and chloride of gold, silver, ruthenium, rhodium, palladium, osmium, iridium, and platinum. These noble metal salts are easily soluble in water to form homogeneous aqueous solutions.

Further, the noble metal salt in the first noble metal salt solution has a concentration of 10-15 g/L. In this concentration range, stable catalytic efficiency and production cost can be balanced.

Further, a method for preparing the first noble metal salt solution includes the step of mixing a noble metal salt with water in a specified mass ratio to obtain the first noble metal salt solution.

Further, the cerium nitrate solution has a molar concentration of 0.5-1.0 mol/L. In this case, a nitrate of cerium is selected so that the nitrate is easily roasted to form nitrogen oxide gas to be removed during roasting. In this cerium nitrate concentration range, cerium nitrate has good dispersibility in the first mixed solution while ensuring complete dissolution of the cerium nitrate.

Further, a method for preparing the first titanium dioxide suspension includes the steps of pretreating first titanium dioxide, and mixing and stirring the pretreated first titanium dioxide and water to obtain the first titanium dioxide suspension.

Further, the content of titanium dioxide in the first titanium dioxide suspension is 500-800 g/L. In this content range, titanium dioxide can encapsulate noble metal ions, reducing the distribution of the noble metal ions in an aqueous phase, improving the coating efficiency, and ensuring the comprehensive catalytic performance of the catalyst.

Further, the step of the first mixing includes:
stirring the first titanium dioxide suspension at a temperature of 25-60° C. for 30-45 min while separately adding the first noble metal salt solution and the cerium nitrate solution into the first titanium dioxide suspension to obtain the first mixed solution, wherein a manner of addition includes dropwise addition.

Further, the step of the first drying includes stirring the first mixed solution for 5-10 h, and then performing drying at 120-130° C. for 10-12 h.

Further, in the step of the first drying, drying is performed by using an air blast drying oven.

Further, the step of the first roasting includes: grinding a first mixture obtained after the first drying into a powder, performing heating to 500-600° C. at a heating rate of 3-5° C./min, performing roasting for 1.5-2 h, and performing cooling to room temperature to obtain the first powder.

Further, in the step of the first roasting, the first mixture is ground into the powder by using an agate mortar.

Further, in the step of the first roasting, the powdery first mixture is roasted by using a muffle furnace.

Further, the step of preparing the second powder includes: subjecting the first cobalt salt solution, the first metal ammonium salt solution and the first carbonate solution to second mixing to obtain a second mixed solution; and subjecting the second mixed solution to second drying and second roasting to obtain the second powder. In this case, the second powder is prepared and a molecular spacing between catalytically active components (metal catalytic particles and metal oxide catalytic particles) in the second powder is reduced.

Further, a concentration of cobalt ions in the first cobalt salt solution is 0.02-0.10 g/L. In this concentration range, the cobalt ions have good dispersibility.

Further, the first cobalt salt solution includes an organic acid cobalt salt solution; and the organic acid cobalt salt solution includes at least one of a cobalt acetate solution, a cobalt formate solution, and a cobalt oxalate solution. These cobalt salt solutions can increase the resistance of the catalyst to poisoning while also not introducing other impurities.

Further, a mass fraction of a first metal ammonium salt in the first metal ammonium salt solution is 0.1-0.5%. In this mass fraction range, the first metal ammonium salt can have good dispersibility.

Further, a method for preparing the first metal ammonium salt solution includes: mixing the first metal ammonium salt with water, and performing stirring for at least 30 min to obtain the first metal ammonium salt solution.

Further, in the first metal ammonium salt solution, the first metal ammonium salt includes one or more of ammonium molybdate, ammonium tungstate, and ammonium metavanadate. In this case, the metal elements in the catalytic particles prepared by the preparation method for the carbon monoxide catalyst provided in the second object of the present disclosure further includes at least one of a molybdenum element, a tungsten element, and a vanadium element.

Further, the first carbonate solution has a concentration of 1-1.5 mol/L. In this concentration range, a carbonate has good dispersibility and stability.

Further, in the first carbonate solution, the carbonate includes one or more of sodium carbonate, potassium carbonate, and lithium carbonate.

Further, the step of the second mixing includes: mixing the first cobalt salt solution with the first metal ammonium salt solution, and adding dropwise the first carbonate solution until a pH is 10 to obtain a suspension; and
stirring the suspension for 3-4 h, allowing the stirred suspension to stand for aging for 2 h or more, performing suction filtration, and washing the obtained suction filtrate to be neutral to obtain a paste.

Further, the step of the second drying includes drying the paste at a temperature of 120-130° C. for 9-10 h.

Further, in the step of the second drying, the paste is dried by using a drying oven.

Further, the step of the second roasting includes: heating the paste obtained after the second drying to 400-500° C. at a heating rate of 3-5° C./min in an air atmosphere, performing roasting for 2-3 h, and performing cooling to room temperature to obtain the second powder.

Further, a mass ratio of the first powder to the second powder is 6:(1-2). In this mass ratio range, the catalytic properties of the noble metal can be utilized to a maximum extent.

Further, the step of preparing the aqueous catalytic particle solution includes: mixing the first powder with the second powder, performing first ball milling, performing third drying, performing third roasting, and performing grinding and sieving to obtain catalytic particles; and mixing the catalytic particles with water to obtain the aqueous catalytic particle solution. In this case, ball milling the first powder and the second powder can further reduce the molecular spacing between the catalytic particles and increase the supporting amount of the catalytic particles.

Further, the step of mixing the first powder with the second powder includes mixing the first powder, the second powder, and deionized water to obtain a powder mixture.

Further, the first ball milling includes the steps of: performing clockwise ball milling on the powder mixture for 60-80 min at a rotation speed of 400 r/min, and performing counterclockwise ball milling on the powder mixture for 60-80 min at a rotation speed of 400 r/min to obtain a ball milled material.

Further, in the first ball milling, milling balls have a particle size of not higher than 1 mm. Further, in the first ball milling, the milling balls include at least one of zirconia balls, alumina balls, and agate balls. Further, in the first ball milling, the ball milling is performed at a temperature of 25-30° C. In this case, a particle size of a product obtained after ball milling the first powder and the second powder is in a nanometer scale. After subsequent drying, roasting and further grinding, dried nano-sized catalytic particles (1 nm to 100 nm) can be obtained.

Further, the step of the third drying includes drying the ball milled material at 120-130° C. for 10-12 h.

Further, the step of the third roasting includes performing roasting at 400-500° C. for 1-2 h.

Further, the step of preparing the carbon monoxide catalyst includes: performing third mixing by using the aqueous catalytic particle solution, the first binder solution, the first thickener solution, the first dispersant solution and the water retaining agent to obtain a first supported slurry; and subjecting the first supported slurry to first supporting with a first support, and performing fourth roasting to obtain the carbon monoxide catalyst.

Further, a mass ratio of the aqueous catalytic particle solution to the first binder solution to the first thickener solution to the first dispersant solution to the water retaining agent is (1-5):(0.5-4):(0.5-3):(0.5-2):1. In this mass ratio range, the slurry can be made more stable, so as to improve the supporting amount, the supporting uniformity, the mechanical stability, and the like of active components of the catalyst.

Further, in the aqueous catalytic particle solution, a mass ratio of the catalytic particles to the water is 1:(0.3-3). In this mass ratio range, the catalytic particles can be uniformly dispersed in the first supported slurry.

Further, the catalytic particles have a mesh size of 20-40 meshes. In this mesh size range, the catalyst has a large specific surface area and good mechanical stability.

Further, a mass fraction of a first binder in the first binder solution is 1-15%. In this mass fraction range, the first binder can be well dispersed in the first supported slurry.

Further, the first binder includes one or two or more of calcium silicate, sodium silicate, calcium aluminate, phenolic resin, diatomaceous earth, alumina sol, silica sol, kaolin, attapulgite, sodium silicate, bentonite, montmorillonite, and pseudoboehmite.

Further, a method for preparing the first binder solution includes the steps of: mixing a specified ratio of the first binder with water, and performing stirring for at least 30 min to obtain the first binder solution; and the first binder solution with a mass fraction of 1-15% is prepared by using deionized water as a solvent, and stirring should be performed at 100-150 r/min for 30 min before addition. At this rotation speed and stirring time, the first binder and the deionized water can be fully and uniformly mixed, while the dispersibility in the first supported slurry can be ensured.

Further, a mass fraction of a first thickener in the first thickener solution is 1-20%. In this mass fraction range, the first thickener can be well dispersed in the first supported slurry.

Further, the first thickener includes one or two or more of hydroxymethyl cellulose, hydroxymethyl propyl cellulose, carboxymethyl cellulose, hydroxyethyl cellulose, hydroxyethyl methyl cellulose, cellulose ether, and starch.

Further, a method for preparing the first thickener solution includes the steps of: mixing a specified ratio of the first thickener with water, and performing stirring for at least 30 min to obtain the first thickener solution.

Further, in the first dispersant solution, a mass fraction of a first dispersant is 1-20%, and a mass fraction of water is 80-99%. In this mass fraction range, the first dispersant can be well dispersed in the first supported slurry.

Further, the first dispersant includes one or two or more of polyacrylic acid, polypropylene, polystyrene, polyethylene wax, polyvinyl ether, polyvinyl ester, polyvinyl acetate, polyethylene, polyacrylamide, sodium polyacrylate, polyethylene glycol, and polyvinyl alcohol.

Further, the water retaining agent includes one or two or more of glycerol, lignin, sodium alginate, polyacrylamide, sodium polyacrylate, potassium polyacrylate, and ammonium polyacrylate.

Further, the step of the third mixing includes: first mixing and stirring the first binder solution and the first dispersant solution in a specified ratio, adding the aqueous catalytic particle solution, performing stirring, adding the first thickener solution and the water retaining agent, performing stirring, and finally adjusting a pH to be 4-10 to obtain the first supported slurry. The first binder and the first dispersant are mixed first to ensure that the two can be fully and uniformly mixed, then the aqueous catalytic particle solution is added so that the catalytic particles are uniformly dispersed in the obtained mixture under the action of the first dispersant, and finally the water retaining agent is added so that after the slurry is stabilized, water retention is performed; and the thickener is added after addition of the catalytic particles and before addition of the water retaining agent, so that the catalytic particles can be uniformly dispersed in the supported slurry, while enabling the thickener itself to be uniformly dispersed in the supported slurry. Thus, the preparation in this order can improve the supporting amount, the supporting uniformity, the mechanical stability, and the like of active components of the catalyst in the first support.

Further, during mixing and stirring the first binder solution and the first dispersant solution, a stirring rate is 50-400 r/min and the stirring time is 1-2 h. At this stirring rate and stirring time, the first binder solution and the first dispersant solution are uniformly mixed to form a homogeneous solution.

Further, after the aqueous catalytic particle solution is added, the stirring is performed at a stirring rate of 50-400 r/min for 0.5-1 h. At this stirring rate and stirring time, the catalytic particles can be uniformly dispersed, improving catalytic stability.

Further, after the first thickener solution and the water retaining agent are added, the stirring is performed at a stirring rate of 50-400 r/min for 2-3 h. At this stirring rate and stirring time, uniform mixing of the components (the first binder, the first dispersant, the catalytic particles, the first thickener and the water retaining agent) in the first supported slurry can be ensured.

Further, the step of the first supporting includes applying the first supported slurry to a pretreated first support with a vacuum coater. The first supported slurry is applied to the first support in a coating manner. Vacuum coating can increase the coating strength, control the supporting amount, and avoid excessive waste of the slurry.

Further, the first support is one or more of cordierite, honeycomb ceramic, glass fiber, a porous carbon material, and a hierarchical porous carbon material.

Further, the step of the fourth roasting includes: drying a slurry obtained after the first supporting at 90-110° C. for 12-14 h until a dewatering rate of the slurry is not less than 90%, performing heating to 350-400° C. at a heating rate of 2-32° C./min, and performing roasting for 1.5-2 h to obtain the carbon monoxide catalyst. In this case, the slurry is dried at low temperature and then roasted at high temperature to obtain the carbon monoxide catalyst with a smooth and crack-free surface.

A third object of the present disclosure is to provide use of the carbon monoxide catalyst according to the first object of the present disclosure or the carbon monoxide catalyst prepared by the preparation method according to the second object of the present disclosure in the field of removing carbon monoxide pollutants.

### BRIEF DESCRIPTION OF DRAWINGS

FIG. 1 is a schematic flow diagram of a preparation method for a carbon monoxide catalyst according to an example of the present disclosure;

FIG. 2 is a schematic flow diagram of another preparation method for a carbon monoxide catalyst according to an example of the present disclosure;

FIG. 3 is a schematic diagram of an experimental device for carbon monoxide catalysis by catalysts involved in Examples of the present disclosure;

FIG. 4 is a schematic diagram showing the catalytic efficiency of carbon monoxide catalysts prepared in Examples 1-6 in Examples of the present disclosure; and

FIG. 5 is a schematic diagram showing the catalytic efficiency of carbon monoxide catalysts prepared by another preparation method inf Examples 7-11 in Examples of the present disclosure.

### DETAILED DESCRIPTION OF THE INVENTION

In order to make the objects, technical solutions and advantages of the present disclosure more clear, the present disclosure will be further described in detail with reference to the accompanying drawings and the examples. It should be understood that the specific examples described herein are merely illustrative of the present disclosure and are not intended to limit the present disclosure.

On the contrary, the present disclosure is intended to cover any replacements, modifications, equivalents, and solutions as defined by the appended claims within the spirit and scope of the present disclosure. Further, in order to provide the public with a better understanding of the present disclosure, in the following detailed description of the present disclosure, some specific details are described in detail. The present disclosure may be fully understood by those skilled in the art without these detailed descriptions.

The following examples serve to illustrate the present disclosure. In the examples, unless otherwise indicated, parts are parts by weight, percentages are percentages by weight, and temperatures are in degrees Celsius. A relationship between fractions by weight and parts by volume is the same as a relationship between grams and cubic centimeters.

Catalytic oxidation is one of the most effective methods for CO removal, and supported platinum group noble metal catalysts have good catalytic activity for CO oxidation. Currently, much research on supported platinum and other noble metal catalysts has focused on improving low-temperature catalytic activity of noble metal particles by adjusting the particle size, improving dispersive catalyst support on noble metals, and changing the electronic state of the noble metals and adjusting the local structural effects of active sites by using an additive.

A preparation method is an important factor affecting the performance of a catalyst. The key to improving the catalytic performance of a supported catalyst is to adjust the size of the supported catalyst, and selection of a pre-proportioning method has a significant impact on the morphology of the catalyst. The preparation method can also affect the dispersion of noble metal particles in a support and is the key to achieving high catalytic activity.

Based on the above contents, an example of the present disclosure provides a carbon monoxide catalyst and a preparation method therefor and use thereof. The carbon monoxide catalyst has high activity and an applicable temperature range, and catalytic oxidation starts at 120° C. and the catalytic efficiency at 220° C. can reach 90% or more. In the preparation method, the carbon monoxide catalyst prepared by an impregnation-reduction method has more negatively charged noble metals and has the best catalytic activity.

Specific solutions are as follows:
“Carbon monoxide catalyst”
A first object of an example of the present disclosure is to provide a carbon monoxide catalyst, including a support and metallic catalytic particles; or metal catalytic particles and metal oxide catalytic particles supported in the support, wherein
metals in the metal catalytic particles or the metal oxide catalytic particles include a noble metal, titanium, cerium, cobalt, nickel and molybdenum.

According to the carbon monoxide catalyst provided in the example of the present disclosure, the support is used to support metal particles to increase the surface area and active sites of the catalyst; and both the metal catalytic particles and the metal oxide catalytic particles are used to catalyze the generation of environmentally friendly compounds from carbon monoxide. The noble metal is used to reduce the activation energy of carbon monoxide oxidation, playing a catalytic oxidation role; the titanium is used to increase the stability of noble metal catalysis; and the cerium, cobalt, nickel, and molybdenum are used to increase the resistance of noble metals to poisoning. Due to high stability of the selected support and metal to an acid, the carbon monoxide catalyst has high sulfur resistance and water resistance, resulting in high catalytic stability in sintering flue gas purification. The carbon monoxide catalyst has high activity and an applicable temperature range, and catalytic oxidation starts at 120° C. and the catalytic efficiency at 220° C. can reach 90% or more.

In an example, the carbon monoxide catalyst provided in the example of the present disclosure has a catalytic principle of promoting a redox reaction of a target gas. Therefore, the carbon monoxide catalyst provided in the example of the present disclosure can also be used for the catalysis of other combustible gases such as methane, ethanol, hydrogen, and low volatile organic compounds.

In some examples, a supporting amount of the metal catalytic particles is 90-150 kg/m³. In this range of the metal supporting amount, the catalyst has high adsorption capacity for carbon monoxide and is also less prone to agglomeration during the catalysis process. Exemplarily, the supporting amount of the metal catalytic particles may be 90 kg/m³, 100 kg/m³, 110 kg/m³, 120 kg/m³, 130 kg/m³, 140 kg/m³, 150 kg/m³, other typical but non-limiting supporting amounts or a range between any two supporting amounts.

In some examples, the metal catalytic particles have a particle size in the range of 1-100 nm. In this particle size range of the metal catalytic particles, the catalytic efficiency and catalytic stability of the catalyst are optimal. Exemplarily, the particle size of the metal catalytic particles can be 1 nm, 10 nm, 20 nm, 30 nm, 40 nm, 50 nm, 60 nm, 70 nm, 80 nm, 90 nm, 100 nm, other typical but non-limiting particle sizes or a range between any two particle sizes.

In some examples, a supporting amount of the metal oxide catalytic particles is 90-150 kg/m³. In this range of the metal supporting amount, the catalyst has high adsorption capacity for carbon monoxide and is also less prone to agglomeration during the catalysis process. Exemplarily, the supporting amount of the metal oxide catalytic particles may be 90 kg/m³, 100 kg/m³, 110 kg/m³, 120 kg/m³, 130 kg/m³, 140 kg/m³, 150 kg/m³, other typical but non-limiting supporting amounts or a range between any two supporting amounts.

In some examples, the metal oxide catalytic particles have a particle size in the range of 1-100 nm. In this particle size range of the metal oxide catalytic particles, the catalytic efficiency and supporting stability of the catalyst are optimal. Exemplarily, the particle size of the metal oxide catalytic particles can be 1 nm, 10 nm, 20 nm, 30 nm, 40 nm, 50 nm, 60 nm, 70 nm, 80 nm, 90 nm, 100 nm, other typical but non-limiting particle sizes or a range between any two particle sizes.

In some examples, the noble metal includes one or more of gold, silver, ruthenium, rhodium, palladium, osmium, iridium, and platinum. These noble metals are active components for catalyzing carbon monoxide and can effectively catalyze carbon monoxide.

In some examples, the support includes one or more of cordierite, honeycomb ceramic, glass fiber, a porous carbon material, and a hierarchical porous carbon material.

In some examples, the carbon monoxide catalyst includes the following metal elements in percentage by mass: 0.5%-1.0% the noble metal, 0.5%-1.0% titanium, 0.5%-1.0% cerium, 0.5%-1.0% cobalt, 0.5%-1.0% nickel, and 0.5%-1.0% molybdenum. Exemplarily, the mass fraction of the noble metal can be 0.5%, 0.6%, 0.7%, 0.8%, 0.9%, 1.0%, other typical but non-limiting mass fractions or a range between any two mass fractions; the mass fraction of titanium can be 0.5%, 0.6%, 0.7%, 0.8%, 0.9%, 1.0%, other typical but non-limiting mass fractions or a range between any two mass fractions; the mass fraction of cerium can be 0.5%, 0.6%, 0.7%, 0.8%, 0.9%, 1.0%, other typical but non-limiting mass fractions or a range between any two mass fractions; the mass fraction of cobalt may be 0.5%, 0.6%, 0.7%, 0.8%, 0.9%, 1.0%, other typical but non-limiting mass fractions or a range between any two mass fractions; the mass fraction of nickel may be 0.5%, 0.6%, 0.7%, 0.8%, 0.9%, 1.0%, other typical but non-limiting mass fractions or a range between any two mass fractions; and the mass fraction of molybdenum may be 0.5%, 0.6%, 0.7%, 0.8%, 0.9%, 1.0%, other typical but non-limiting mass fractions or a range between any two mass fractions. In this mass fraction range, the carbon monoxide catalyst has high sulfur resistance and water resistance, resulting in high catalytic stability in sintering flue gas purification. The carbon monoxide catalyst has high activity and an applicable temperature range, and catalytic oxidation starts at 120° C. and the catalytic efficiency at 220° C. can reach 90% or more.

### “First Preparation Method for Carbon Monoxide Catalyst”

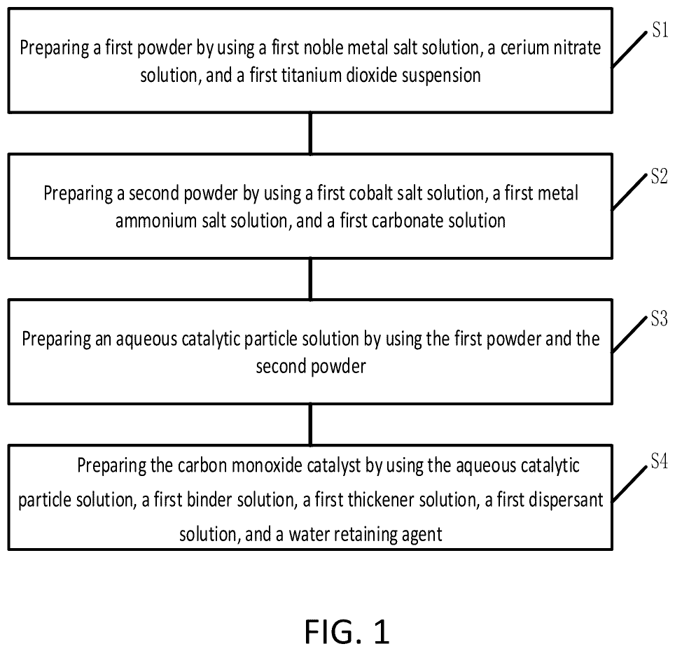

A second object of an example of the present disclosure is to provide a preparation method for a carbon monoxide catalyst, as shown in FIG. 1, including the steps of:
S1, preparing a first powder by using a first noble metal salt solution, a cerium nitrate solution and a first titanium dioxide suspension;
S2, preparing a second powder by using a first cobalt salt solution, a first metal ammonium salt solution, and a first carbonate solution;
S3, preparing an aqueous catalytic particle solution by using the first powder and the second powder; and
S4, preparing the carbon monoxide catalyst by using the aqueous catalytic particle solution, a first binder solution, a first thickener solution, a first dispersant solution, and a water retaining agent.

In the preparation method for the carbon monoxide catalyst provided in the second object of the example of the present disclosure, the aqueous catalytic particle solution is first prepared, then the aqueous catalytic particle solution is prepared into a first supported slurry, and the carbon monoxide catalyst is prepared from the first supported slurry and a first support. The aqueous catalytic particle solution is prepared first, which can reduce a molecular spacing between catalytically active components (metal catalytic particles and metal oxide catalytic particles) and provide more active sites for catalysis under the same conditions; moreover, a supporting amount of the first support can be reduced under the premise of the same catalytic effect, and the catalytically active components can be uniformly distributed on the support, finally enabling the carbon monoxide catalyst to have a larger specific surface area and supporting strength; and the aqueous catalytic particle solution is prepared into the first supported slurry, and the first supported slurry is subjected to first supporting with the first support, followed by roasting to support the catalytic particles on the first support. Wherein the catalytic particles are metal catalytic particles; or metal catalytic particles and metal oxide catalytic particles.

Metal elements in the catalytic particles prepared by the preparation method for the carbon monoxide catalyst provided in the second object of the example of the present disclosure include a noble metal element, a cerium element and a titanium element.

In some examples, in the above step S1, the step of preparing the first powder includes: subjecting the first noble metal salt solution, the cerium nitrate solution and the first titanium dioxide suspension to first mixing to obtain a first mixed solution; and subjecting the first mixed solution to first drying and first roasting to obtain the first powder. In this case, the first powder is prepared and a molecular spacing between catalytically active components (metal catalytic particles and metal oxide catalytic particles) in the first powder is reduced.

In some examples, a noble metal salt in the first noble metal salt solution includes one or more of a nitrate, chlorate, and chloride of gold, silver, ruthenium, rhodium, palladium, osmium, iridium, and platinum. These noble metal salts are easily soluble in water to form homogeneous aqueous solutions.

In some examples, the noble metal salt in the first noble metal salt solution has a concentration of 10-15 g/L. In this concentration range, stable catalytic efficiency and production cost can be balanced. Exemplarily, the concentration of the noble metal salt may be 10 g/L, 11 g/L, 12 g/L, 13 g/L, 14 g/L, 15 g/L, other typical but non-limiting concentrations or a range between any two concentrations. In this concentration range, stable catalytic efficiency and production cost can be balanced.

In some specific examples, a method for preparing the first noble metal salt solution includes the step of mixing a noble metal salt with water in a specified mass ratio to obtain the first noble metal salt solution.

In some examples, in the above step S1, the cerium nitrate solution has a molar concentration of 0.5-1.0 mol/L. In this case, a nitrate of cerium is selected so that the nitrate is easily roasted to form nitrogen oxide gas to be removed during roasting. In this cerium nitrate concentration range, cerium nitrate has good dispersibility in the first mixed solution while ensuring complete dissolution of the cerium nitrate. Exemplarily, the molar concentration of the cerium nitrate solution can be 0.5 mol/L, 0.6 mol/L, 0.7 mol/L, 0.8 mol/L, 0.9 mol/L, 1.0 mol/L, other typical but non-limiting molar concentrations or a range between any two molar concentrations.

In some examples, in the above step S1, a method for preparing the first titanium dioxide suspension includes the steps of pretreating first titanium dioxide, and mixing and stirring the pretreated first titanium dioxide and water to obtain the first titanium dioxide suspension.

In some examples, the step of pretreating first titanium dioxide includes performing heating to 700-800° C. at a heating rate of 3-5° C./min in an air atmosphere, and performing roasting for 3-4 h to obtain the pretreated first titanium dioxide.

In some specific examples, the first titanium dioxide is pretreated by roasting by using a muffle furnace.

In some examples, in the above step S1, the content of first titanium dioxide in the first titanium dioxide suspension is 500-800 g/L. In this content range, titanium dioxide can encapsulate noble metal ions, reducing the distribution of the noble metal ions in an aqueous phase, improving the coating efficiency, and ensuring the comprehensive catalytic performance of the catalyst. Exemplarily, the content of first titanium dioxide in the first titanium dioxide suspension may be 500 g/L, 600 g/L, 700 g/L, 800 g/L, other typical but non-limiting contents or a range between any two contents.

In some examples, the step of the first mixing includes:
stirring the first titanium dioxide suspension at a temperature of 25-60° C. for 30-45 min while separately adding the first noble metal salt solution and the cerium nitrate solution into the first titanium dioxide suspension to obtain the first mixed solution, wherein a manner of addition includes dropwise addition.

In some examples, the step of the first drying includes stirring the first mixed solution for 5-10 h, and then performing drying at 120-130° C. for 10-12 h.

In some specific examples, in the step of the first drying, drying is performed by using an air blast drying oven.

In some examples, the step of the first roasting includes: grinding a first mixture obtained after the first drying into a powder, performing heating to 500-600° C. at a heating rate of 3-5° C./min, performing roasting for 1.5-2 h, and performing cooling to room temperature to obtain the first powder.

In some specific examples, in the step of the first roasting, the first mixture is ground into the powder by using an agate mortar.

In some specific examples, in the step of the first roasting, the powdery first mixture is roasted by using a muffle furnace.

In some examples, in the above step S2, the step of preparing the second powder includes: subjecting the first cobalt salt solution, the first metal ammonium salt solution and the first carbonate solution to second mixing to obtain a second mixed solution; and subjecting the second mixed solution to second drying and second roasting to obtain the second powder. In this case, the second powder is prepared and a molecular spacing between catalytically active components (metal catalytic particles and metal oxide catalytic particles) in the second powder is reduced.

In some examples, in the above step S2, a concentration of cobalt ions in the first cobalt salt solution is 0.02-0.10 g/L. In this concentration range, the cobalt ions have good dispersibility.

In some specific examples, the first cobalt salt solution includes an organic acid cobalt salt solution; and the organic acid cobalt salt solution includes at least one of a cobalt acetate solution, a cobalt formate solution, and a cobalt oxalate solution. These cobalt salt solutions can increase the resistance of the catalyst to poisoning while also not introducing other impurities.

In some specific examples, a method for preparing the cobalt acetate solution includes the steps of:
obtaining a mass and/or volume of cobalt acetate and a solvent according to the concentration of the cobalt acetate solution, wherein the solvent includes absolute ethanol and deionized water; and the deionized water is combined with the absolute ethanol to increase the solubility and dispersion degree of cobalt acetate, facilitating a reaction between cobalt acetate and an alkali, and making it easier to wash after precipitation; and
after mixing cobalt acetate with the absolute ethanol, and then mixing the obtained mixture with the deionized water to obtain the cobalt acetate solution.

In some examples, in the above step S2, a mass fraction of a first metal ammonium salt in the first metal ammonium salt solution is 0.1-0.5%. In this mass fraction range, the first metal ammonium salt can have good dispersibility. Exemplarily, the mass fraction of the first metal ammonium salt can be 0.1%, 0.2%, 0.3%, 0.4%, 0.5%, other typical but non-limiting mass fractions or a range between any two mass fractions.

In some specific examples, a method for preparing the first metal ammonium salt solution includes: mixing the first metal ammonium salt with water, and performing stirring for at least 30 min to obtain the first metal ammonium salt solution.

In some specific examples, in the first metal ammonium salt solution, the first metal ammonium salt includes one or more of ammonium molybdate, ammonium tungstate, and ammonium metavanadate. In this case, the metal elements in the catalytic particles prepared by the preparation method for the carbon monoxide catalyst provided in the second object of the present disclosure further includes at least one of a molybdenum element, a tungsten element, and a vanadium element.

In some examples, in the above step S2, the first carbonate solution has a concentration of 1-1.5 mol/L. In this concentration range, a carbonate has good dispersibility and stability. Exemplarily, the concentration of the first carbonate solution can be 1 mol/L, 1.1 mol/L, 1.2 mol/L, 1.3 mol/L, 1.4 mol/L, 1.5 mol/L, other typical but non-limiting concentrations or a range between any two concentrations.

In some specific examples, in the first carbonate solution, the carbonate includes one or more of sodium carbonate, potassium carbonate, and lithium carbonate.

In some examples, in the above step S2, the step of the second mixing includes: mixing the first cobalt salt solution with the first metal ammonium salt solution, and adding dropwise the first carbonate solution until a pH is 10 to obtain a suspension; and
stirring the suspension for 3-4 h, allowing the stirred suspension to stand for aging for 2 h or more, performing suction filtration, and washing the obtained suction filtrate to be neutral to obtain a paste.

In some examples, in the above step S2, the step of the second drying includes drying the paste at a temperature of 120-130° C. for 9-10 h.

In some examples, in the step of the second drying, the paste is dried by using a drying oven.

In some examples, in the above step S2, the step of the second roasting includes: heating the paste obtained after the second drying to 400-500° C. at a heating rate of 3-5° C./min in an air atmosphere, performing roasting for 2-3 h, and performing cooling to room temperature to obtain the second powder.

In some examples, in the above step S3, the step of preparing the aqueous catalytic particle solution includes: mixing the first powder with the second powder, performing first ball milling, performing third drying, performing third roasting, and performing grinding and sieving to obtain catalytic particles; and mixing the catalytic particles with water to obtain the aqueous catalytic particle solution. In this case, ball milling the first powder and the second powder can further reduce the molecular spacing between the catalytic particles and increase the supporting amount of the catalytic particles.

In some examples, in the above step S3, a mass ratio of the first powder to the second powder is 6:(1-2). In this mass ratio range, the catalytic properties of the noble metal can be utilized to a maximum extent. Exemplarily, the mass ratio of the first powder to the second powder can be 6:1, 5:1, 4:1, 3:1, other typical but non-limiting mass ratios, or a range between any two mass ratios.

In some examples, in the above step S3, the step of mixing the first powder with the second powder includes mixing the first powder, the second powder, and deionized water to obtain a powder mixture.

In some examples, a mass ratio of a total mass of the first powder and the second powder to the deionized water in the powder mixture is (2-10):1, and can be, for example, 2:1, 3:1, 4:1, 5:1, 6:1, 7:1, 8:1, 9:1, other typical but non-limiting mass ratios or a range between any two mass ratios. In this mass ratio range, the powder mixture obtained after mixing is easily subjected to the first ball milling and a nano-sized product is obtained.

In some examples, in the above step S3, the first ball milling includes the steps of: performing clockwise ball milling on the powder mixture for 60-80 min at a rotation speed of 400 r/min, and performing counterclockwise ball milling on the powder mixture for 60-80 min at a rotation speed of 400 r/min to obtain a ball milled material.

In some examples, in the first ball milling, milling balls have a particle size of not higher than 1 mm. In some specific examples, in the first ball milling, the milling balls include at least one of zirconia balls, alumina balls, and agate balls. In some specific examples, in the first ball milling, the ball milling is performed at a temperature of 25-30° C. In this case, a particle size of a product obtained after ball milling the first powder and the second powder is in a nanometer scale. After subsequent drying, roasting and further grinding, dried nano-sized catalytic particles (1 nm to 100 nm) can be obtained.

In an example, the particle size of the milling balls is not greater than 1 mm, and may be, for example, 1 mm, 10 mm, 15 mm, 20 mm, 500 μm, 100 μm, other typical but non-limiting particle sizes or a range between any two particle sizes. In this case, the particle size of the product obtained after ball milling is in a nanometer scale. After subsequent first roasting, a dried nano-sized first intermediate product (1-100 nm) can be obtained.

In some examples, in the above step S3, the step of the third drying includes drying the ball milled material at 120-130° C. for 10-12 h.

In some examples, in the above step S3, the step of the third roasting includes performing roasting at 400-500° C. for 1-2 h.

In some examples, in the above step S3, the catalytic particles have a mesh size of 20-40 meshes. In this mesh size range, the catalyst has a large specific surface area and good mechanical stability.

In some examples, in the above step S4, the step of preparing the carbon monoxide catalyst includes: performing third mixing by using the aqueous catalytic particle solution, the first binder solution, the first thickener solution, the first dispersant solution and the water retaining agent to obtain a first supported slurry; and subjecting the first supported slurry to first supporting with a first support, and performing fourth roasting to obtain the carbon monoxide catalyst.

In some examples, in the above step S4, a mass ratio of the aqueous catalytic particle solution to the first binder solution to the first thickener solution to the first dispersant solution to the water retaining agent is:(1-5):(0.5-4):(0.5-3):(0.5-2):1. Exemplarily, the mass ratio can be 1:1:1:1, 1:0.5:0.5:1, 5:4:2:1:1, other typical but non-limiting mass ratios or a range between any two mass ratios. In this mass ratio range, the slurry can be made more stable, so as to improve the supporting amount, the supporting uniformity, the mechanical stability, and the like of active components of the catalyst.

In some examples, in the above step S4, in the aqueous catalytic particle solution, a mass ratio of the catalytic particles to the water is 1:(0.3-3). In this mass ratio range, the catalytic particles can be uniformly dispersed in the first supported slurry. Exemplarily, the mass ratio of the catalytic particles to the water can be 1:0.3, 1:0.5, 1:0.7, 1:0.9, 1:1, 1:1.1, 1:1.3, 1:1.5, 1:1.7, 1:1.9, 1:2, 1:2.1, 1:2.3, 1:2.5, 1:2.7, 1:2.9, 1:3, other typical but non-limiting mass ratios or a range between any two mass ratios.

In some examples, in the above step S4, a mass fraction of a first binder in the first binder solution is 1-15%. Exemplarily, the mass fraction of the first binder can be 1%, 5%, 10%, 15%, 20%, other typical but non-limiting mass fractions or a range between any two mass fractions. In this mass fraction range, the first binder can be well dispersed in the first supported slurry.

In some specific examples, the first binder includes one or more of calcium silicate, sodium silicate, calcium aluminate, phenolic resin, diatomaceous earth, alumina sol, silica sol, kaolin, attapulgite, sodium silicate, bentonite, montmorillonite, and pseudoboehmite.

In some specific examples, a method for preparing the first binder solution includes the steps of: mixing a specified ratio of the first binder with water, and performing stirring for at least 30 min to obtain the first binder solution; and the first binder solution with a mass fraction of 1-15% is prepared by using deionized water as a solvent, and stirring should be performed at 100-150 r/min for 30 min before addition. At this rotation speed and stirring time, the first binder and the deionized water can be fully and uniformly mixed, while the dispersibility in the first supported slurry can be ensured.

In some examples, a mass fraction of a first thickener in the first thickener solution is 1-20%. Exemplarily, the mass fraction of the first thickener may be 1%, 5%, 10%, 15%, 20%, other typical but non-limiting mass fractions or a range between any two mass fractions. At this mass fraction range, the first thickener can be well dispersed in the first supported slurry.

In some specific examples, the first thickener includes one or two or more of hydroxymethyl cellulose, hydroxymethyl propyl cellulose, carboxymethyl cellulose, hydroxyethyl cellulose, hydroxyethyl methyl cellulose, cellulose ether, and starch.

In some specific examples, a method for preparing the first thickener solution includes the steps of: mixing a specified ratio of the first thickener with water, and performing stirring for at least 30 min to obtain the first thickener solution.

In some examples, in the first dispersant solution, a mass fraction of a first dispersant is 1-15%, and a mass fraction of water is 80-99%. Exemplarily, the mass fraction of the first dispersant may be 1%, 5%, 10%, 15%, other typical but non-limiting mass fractions or a range between any two mass fractions. In this mass fraction range, the first dispersant can be well dispersed in the first supported slurry.

In some specific examples, the first dispersant includes one or two or more of polyacrylic acid, polypropylene, polystyrene, polyethylene wax, polyvinyl ether, polyvinyl ester, polyvinyl acetate, polyethylene, polyacrylamide, sodium polyacrylate, polyethylene glycol, and polyvinyl alcohol.

In some specific examples, a method for preparing the first dispersant solution includes the steps of weighting 1%-15% dispersant powder and 85%-99% deionized water without other trace elements, performing mixing and performing stirring at a constant temperature, and after standing at room temperature, performing stirring at a constant temperature again; and performing cooling to room temperature to form the first dispersant solution having a mass concentration of 1-15%.

In some examples, the water retaining agent includes one or two or more of glycerol, lignin, sodium alginate, polyacrylamide, sodium polyacrylate, potassium polyacrylate, and ammonium polyacrylate.

In some examples, the step of the third mixing includes: first mixing and stirring the first binder solution and the first dispersant solution in a specified ratio, adding the aqueous catalytic particle solution, performing stirring, adding the first thickener solution and the water retaining agent, performing stirring, and finally adjusting a pH to be 4-10 to obtain the first supported slurry. In this case, the first binder and the first dispersant are mixed first to ensure that the two can be fully and uniformly mixed, then the aqueous catalytic particle solution is added so that the catalyst particles are uniformly dispersed in the obtained mixture under the action of the first dispersant, and finally the water retaining agent is added so that after the slurry is stabilized, water retention is performed; and the thickener is added after addition of the catalytic particles and before addition of the water retaining agent, so that the catalytic particles can be uniformly dispersed in the supported slurry, while enabling the thickener itself to be uniformly dispersed in the supported slurry. Thus, the preparation in this order can improve the supporting amount, the supporting uniformity, the mechanical stability, and the like of active components of the catalyst in the first support.

In an example, the first supported slurry has a pH of 4-10. For example, the pH can be 4, 5, 6, 7, 8, 9, 10, other typical but non-limiting pHs or a range between any two pHs. The pH of the first supported slurry has a direct effect on the catalytic performance of the carbon monoxide catalyst, in this pH range, the supporting amount of noble metals and other metals on the first support is high, and at the same time, active sites of the carbon monoxide catalyst are also correspondingly high, and the high supporting amount of other metals results in high sulfur resistance and water resistance of the carbon monoxide catalyst, resulting in high catalytic stability of the carbon monoxide catalyst in sintering flue gas purification.

In some specific examples, the pH is adjusted by using an acid solution or an alkali solution.

In some specific examples, the acid solution is one or more of a citric acid solution, a tartaric acid solution, a hydrochloric acid solution, an oxalic acid solution, a lactic acid solution, a trichloroacetic acid solution, a monochloroacetic acid solution, and an arginine solution.

In some specific examples, the alkali solution is one or more of hydrazine hydrate, a sodium hydroxide solution, a sodium carbonate solution, a sodium bicarbonate solution, and ammonia water.

In some specific examples, during mixing and stirring the first binder solution and the first dispersant solution, a stirring rate is 50-400 r/min and the stirring time is 1-2 h. At this stirring rate and stirring time, the first binder solution and the first dispersant solution are uniformly mixed to form a homogeneous solution.

In some specific examples, after the aqueous catalytic particle solution is added, the stirring is performed at a stirring rate of 50-400 r/min for 0.5-1 h. At this stirring rate and stirring time, the catalytic particles can be uniformly dispersed, improving catalytic stability.

In some specific examples, after the first thickener solution and the water retaining agent are added, the stirring is performed at a stirring rate of 50-400 r/min for 2-3 h. At this stirring rate and stirring time, uniform mixing of the components (the first binder, the first dispersant, the catalytic particles, the first thickener and the water retaining agent) in the first supported slurry can be ensured.

In some examples, in the above step S4, the step of the first supporting includes applying the first supported slurry to a pretreated first support with a vacuum coater. The first supported slurry is applied to the first support in a coating manner. Vacuum coating can increase the coating strength, control the supporting amount, and avoid excessive waste of the slurry.

In some specific examples, the first support is one or more of cordierite, honeycomb ceramic, glass fiber, a porous carbon material, and a hierarchical porous carbon material.

In some specific examples, pretreating the first support includes the steps of: first washing the first support with distilled water, then placing the washed first support in acetic acid at a concentration of 5-25% by volume, performing sealing with a lid, and then soaking the first support for 3-4 h while heating at a constant temperature of 60-80° C.;

after the soaked first support is taken out, drying the first support at room temperature for 1.5-3.5 h, and drying the first support at 60-120° C. for 4-10 h; and

then roasting the first support in a muffle furnace at 350-450° C. for 4-6 h, and performing cooling to room temperature to obtain the pretreated first support.

In some examples, in the above step S4, the step of the fourth roasting includes: drying a slurry obtained after the first supporting at 90-110° C. for 12-14 h until a dewatering rate of the slurry is not less than 90%, performing heating to 350-400° C. at a heating rate of 2-32° C./min, and performing roasting for 1.5-2 h to obtain the carbon monoxide catalyst. In this case, the slurry is dried at low temperature and then roasted at high temperature to obtain the carbon monoxide catalyst with a smooth and crack-free surface.

### “Second Preparation Method for Carbon Monoxide Catalyst”

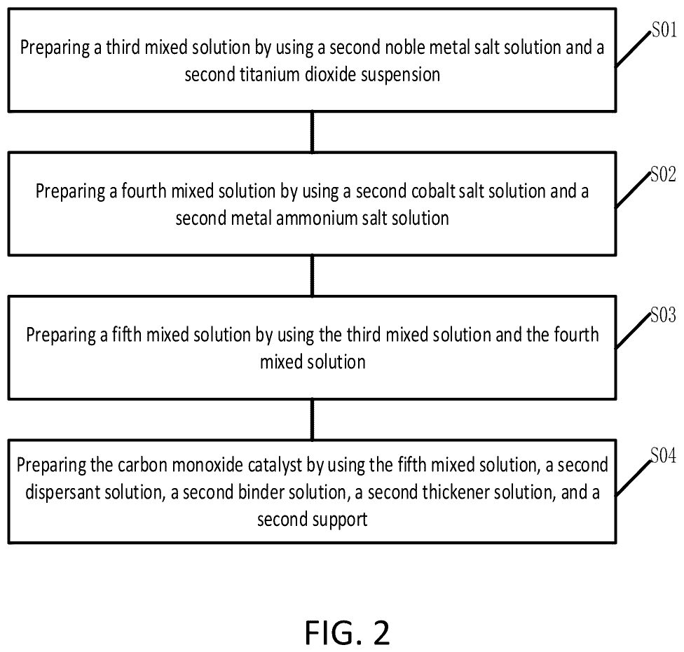

A third object of an example of the present disclosure is to provide another preparation method for a carbon monoxide catalyst, as shown in FIG. 2, including the steps of:
S01, preparing a third mixed solution by using a second noble metal salt solution and a second titanium dioxide suspension;
S02, preparing a fourth mixed solution by using a second cobalt salt solution and a second metal ammonium salt solution;
S03, preparing a fifth mixed solution by using the third mixed solution and the fourth mixed solution; and
S04, preparing the carbon monoxide catalyst by using the fifth mixed solution, a second dispersant solution, a second binder solution, a second thickener solution, and a second support.

According to another preparation method for the carbon monoxide catalyst provided in the example of the present disclosure, in the method, the third mixed solution and the fourth mixed solution are separately prepared and are used to prepare the fifth mixed solution, so that metal ions in the fifth mixed solution are dispersed very uniformly, facilitating subsequent preparation of a second supported slurry from the fifth mixed solution, a dispersant, a binder, and a thickener. The second supported slurry is subjected to second supporting and then roasted to support catalytic particles on the second support. The method simplifies the preparation process and eliminates the material loss caused by multi-step roasting; and in the prepared carbon monoxide catalyst, the catalytic particles may be uniformly supported on the support, and finally the carbon monoxide catalyst having a particle size in a nanometer scale is prepared. Metal elements in the carbon monoxide catalyst prepared by another preparation method for the carbon monoxide catalyst provided in the example of the present disclosure include a noble metal element and a titanium element.

In some examples, in the above step S01, the step of preparing the third mixed solution includes subjecting the second noble metal salt solution and the second titanium dioxide suspension to fourth mixing to obtain the third mixed solution.

In some examples, in the above step S01, a second noble metal salt in the second noble metal salt solution includes one or more of a nitrate, chlorate, and chloride of gold, silver, ruthenium, rhodium, palladium, osmium, iridium, and platinum. These noble metal salts are easily soluble in water to form homogeneous aqueous solutions.

In some specific examples, the second noble metal salt in the second noble metal salt solution has a concentration of 10-15 g/L. Exemplarily, the concentration may be 10 g/L, 11 g/L, 12 g/L, 13 g/L, 14 g/L, 15 g/L, other typical but non-limiting concentrations or a range between any two concentrations. In this concentration range, stable catalytic efficiency and production cost can be balanced.

In some specific examples, a method for preparing the second noble metal salt solution includes the step of mixing a noble metal salt with water in a specified mass ratio to obtain the second noble metal salt solution.

In some examples, in the above step S01, a method for preparing the second titanium dioxide suspension includes the steps of pretreating second titanium dioxide, and mixing and stirring the pretreated second titanium dioxide and water to obtain the second titanium dioxide suspension.

In some examples, the step of pretreating second titanium dioxide includes performing heating to 700-800° C. at a heating rate of 5-10° C./min in an air atmosphere, and performing roasting for 3-4 h to obtain the pretreated second titanium dioxide.

In some specific examples, the second titanium dioxide is pretreated by roasting by using a muffle furnace.

In some examples, in the above step S01, the content of titanium dioxide in the second titanium dioxide suspension is 500-800 g/L. Exemplarily, the content may be 500 g/L, 600 g/L, 700 g/L, 800 g/L, other typical but non-limiting contents or a range between any two contents. In this content range, the distribution of the noble metal in an aqueous phase can be reduced, the coating efficiency can be improved, and the comprehensive catalytic performance of the catalyst can be ensured.

In some examples, in the above step S01, the step of the fourth mixing includes:
stirring the second titanium dioxide suspension at a temperature of 20-45° C. for 30-45 min while adding the second noble metal salt solution, and continuing performing stirring for 30-35 min to obtain the third mixed solution, wherein a manner of addition of the second noble metal salt solution includes dropwise addition.

In the step of the fourth mixing, titanium dioxide in the second titanium dioxide suspension can be evenly dispersed by stirring the second titanium dioxide for 30-45 min; and the second titanium dioxide suspension and the second noble metal salt solution may be uniformly stirred by continuing performing stirring for 30-35 min.

In some examples, in the above step S02, the step of preparing the fourth mixed solution includes: subjecting the second cobalt salt solution and the second metal ammonium salt solution to fifth mixing, and adjusting a pH value to be 10-12 to obtain the fourth mixed solution.

In some examples, in the above step S02, a concentration of a cobalt element in the second cobalt salt solution is 0.05-0.15 g/L. Exemplarily, the concentration may be 0.05 g/L, 0.1 g/L, 0.15 g/L, other typical but non-limiting concentrations or a range between any two concentrations. In this case, the second cobalt salt solution provides cobalt needed to prepare the carbon monoxide catalyst.

In some examples, in the above step S02, the second cobalt salt solution includes organic acid cobalt salts such as a cobalt acetate solution, a cobalt formate solution, and a cobalt oxalate solution. These cobalt salt solutions can increase the resistance of the catalyst to poisoning while also not introducing other impurities.

In some specific examples, a method for preparing the cobalt acetate solution includes the steps of:
obtaining a mass and/or volume of cobalt acetate and a 50% ethanol solution according to the concentration of the cobalt acetate solution; and
mixing cobalt acetate with the 50% ethanol solution to obtain the cobalt acetate solution.

In some examples, in the above step S02, a mass fraction of a second metal ammonium salt in the second metal ammonium salt solution is 0.1-0.5%. In this mass fraction range, the second metal ammonium salt can have good dispersibility.

In some specific examples, a method for preparing the second metal ammonium salt solution includes: mixing a specified ratio of the second metal ammonium salt with water, and performing stirring for 30-45 min to obtain the second metal ammonium salt solution.

In some specific examples, the second metal ammonium salt in the second metal ammonium salt solution includes one or more of ammonium molybdate, ammonium tungstate, and ammonium metavanadate. In this case, metal elements in the catalytic particles prepared by the second preparation method for the carbon monoxide catalyst provided in the third object of the example of the present disclosure further include at least one of a molybdenum element, a tungsten element, and a vanadium element.

In some specific examples, preparing the second metal ammonium salt solution includes the steps of:
mixing the second metal ammonium salt with water in a specified ratio, and performing stirring in a water bath at a temperature of 60-65° C. for 25-30 min to obtain the second metal ammonium salt solution.

In some examples, in the above step S02, the step of the fifth mixing includes:
mixing the second metal ammonium salt solution with the second cobalt salt solution under the stirring condition in a water bath at a temperature of 60-65° C. to obtain the fourth mixed solution, wherein the second metal ammonium salt solution is slowly added dropwise into the second cobalt salt solution.

In some specific examples, the step of adjusting the pH value to be 10-12 includes:
when the pH value of the solution is adjusted to be 10-12 with ammonia water, continuing to perform stirring for 30-40 min to obtain the fourth mixed solution.

In some examples, in the above step S03, the step of preparing the fifth mixed solution includes subjecting the third mixed solution and the fourth mixed solution to sixth mixing to obtain the fifth mixed solution.

In some examples, in the above step S03, the step of the sixth mixing includes: obtaining a mass ratio of the third mixed solution to the fourth mixed solution; and
mixing the third mixed solution with the fourth mixed solution to obtain the fifth mixed solution.

In some examples, in the above step S03, the mass ratio of the third mixed solution to the fourth mixed solution is (0.5-3):1. Exemplarily, the mass ratio can be 0.5:1, 1:1, 2:1, 3:1, other typical but non-limiting mass ratios or a range between any two mass ratios. In this case, in this range of the mass ratio of the third mixed solution to the fourth mixed solution, the activity of the catalyst can be ensured, and the catalytic efficiency and stability can be improved.

In some examples, in the above step S04, the step of preparing the carbon monoxide catalyst includes: subjecting the fifth mixed solution, the second dispersant solution, the second binder solution, and the second thickener solution to seventh mixing to obtain a second supported slurry; and subjecting the second supported slurry to second supporting with a second support, and performing fifth roasting to obtain the carbon monoxide catalyst.

In some examples, in the above step S04, the step of the seventh mixing includes:
obtaining mass fractions of the fifth mixed solution, the second dispersant solution, the second binder solution and the second thickener solution: 1-5 wt % the second dispersant solution, 1-5 wt % the second binder solution, and 1-5 wt % the second thickener solution, the balance being the fifth mixed solution; and
first mixing the second binder solution with the second dispersant solution in the above proportion, separately adding the fifth mixed solution and the second thickener solution, performing mixing, and adjusting a pH of the obtained solution to be 4-10 to obtain the second supported slurry.

In some specific examples, the pH is adjusted to be 4-10 by using an acid solution or an alkali solution.

In an example, the second supported slurry has a pH of 4-10. For example, the pH can be 4, 5, 6, 7, 8, 9, 10, other typical but non-limiting pHs or a range between any two pHs. The pH of the second supported slurry has a direct effect on the catalytic performance of the carbon monoxide catalyst, in this pH range, the supporting amount of noble metals and other metals on the second support is high, and at the same time, active sites of the carbon monoxide catalyst are also correspondingly high, and the high supporting amount of other metals results in high sulfur resistance and water resistance of the carbon monoxide catalyst, resulting in high catalytic stability of the carbon monoxide catalyst in sintering flue gas purification.

In some specific examples, the acid solution is one or more of a citric acid solution, a tartaric acid solution, a hydrochloric acid solution, an oxalic acid solution, a lactic acid solution, a trichloroacetic acid solution, a monochloroacetic acid solution, and an arginine solution.

In some specific examples, the alkali solution is one or more of hydrazine hydrate, a sodium hydroxide solution, a sodium carbonate solution, a sodium bicarbonate solution, and ammonia water.

In some examples, in the above step S04, in the second dispersant solution, a mass fraction of a second dispersant is 1-15%, and a mass fraction of water is 85-99%; and the mass fraction of the second dispersant may be 1%, 3%, 5%, 7%, 9%, 11%, 13%, 15%, other typical but non-limiting mass fractions or a range between any two mass fractions. In this mass fraction range, the second dispersant can be well dispersed in the second supported slurry.

In some specific examples, a method for preparing the second dispersant solution includes the steps of weighting 1%-15% dispersant powder and 85%-99% deionized water, performing mixing and performing stirring at a constant temperature, and after standing at room temperature, performing stirring at a constant temperature again; and performing cooling to room temperature to form the second dispersant solution having a mass concentration of 1-15%. The function of the deionized water is to ensure that no other unnecessary elements and impurities are introduced in the preparation process.

In some specific examples, the second dispersant includes one or two or more of polyacrylic acid, polypropylene, polystyrene, polyethylene wax, polyvinyl ether, polyvinyl ester, polyvinyl acetate, polyethylene, polyacrylamide, sodium polyacrylate, polyethylene glycol, and polyvinyl alcohol.

In some examples, in the above step S04, a mass fraction of a second binder in the second binder solution is 1-20%; and the mass fraction of the second binder can be 1%, 5%, 10%, 15%, 20%, other typical but non-limiting mass fractions or a range between any two mass fractions. In this mass fraction range, the second binder can be well dispersed in the second supported slurry.

In some specific examples, the second binder includes one or two or more of calcium silicate, sodium silicate, calcium aluminate, phenolic resin, diatomaceous earth, alumina sol, silica sol, kaolin, attapulgite, sodium silicate, bentonite, montmorillonite, and pseudoboehmite.

In some specific examples, a method for preparing the second binder solution includes the steps of mixing the second binder with water, and performing stirring for at least 30 min to obtain the second binder solution.

In some examples, in the above step S04, a mass fraction of a second thickener in the second thickener solution is 1-20%; and the mass fraction of the second thickener may be 1%, 5%, 10%, 15%, 20%, other typical but non-limiting mass fractions or a range between any two mass fractions. In this mass fraction range, the second thickener can be well dispersed in the solution.

In some specific examples, the second thickener includes one or two or more of hydroxymethyl cellulose, hydroxymethyl propyl cellulose, carboxymethyl cellulose, hydroxyethyl cellulose, hydroxyethyl methyl cellulose, cellulose ether, and starch.

In some specific examples, a method of preparing the second thickener solution includes the steps of placing the second thickener in deionized water, maintaining a mass fraction of the second thickener to be 1-20%, and performing stirring at normal temperature for 30-45 min.

In some examples, in the above step S04, the step of the second supporting includes: applying the second supported slurry to a pretreated second support with a vacuum coater. The second supported slurry is applied to the second support by vacuum coating, which can better control the supporting amount, improve supporting strength, and form a regular channel. And the carbon monoxide catalyst obtained after vacuum coating and roasting has a particle size of 50-200 nm, which is a nano-sized catalyst material.

In some examples, in the above step S04, the second support is one or more of cordierite, honeycomb ceramic, glass fiber, a porous carbon material, and a hierarchical porous carbon material.

In some specific examples, pretreating the second support includes the steps of: first washing the second support with distilled water, then placing the washed second support in acetic acid at a concentration of 5-25% by volume, performing sealing with a lid, and then soaking the second support for 3-4 h while heating at a constant temperature of 60-80° C.;
after the soaked second support is taken out, drying the second support at room temperature for 1.5-3.5 h, and drying the second support at 60-80° C. for 4-10 h; and
then roasting the second support in a muffle furnace at 350-450° C. for 4-6 h, and performing cooling to room temperature to obtain the pretreated second support.

In some examples, in the above step S04, the step of the fifth roasting includes: drying a slurry obtained after the second supporting at 90-110° C. for 12-14 h until a dewatering rate of the slurry is not less than 90%, performing heating to 350-400° C. at a heating rate of 2-20° C./min, and performing roasting for 1.5-2 h to obtain the carbon monoxide catalyst. In this case, the slurry is dried at low temperature and then roasted at high temperature to obtain the carbon monoxide catalyst with a smooth and crack-free surface.

### “Use”

A fourth object of an example of the present disclosure is to provide use of the carbon monoxide catalyst according to the first object of the present disclosure or the carbon monoxide catalyst prepared by the preparation method according to the second object or the third object of the present disclosure in the field of removing carbon monoxide pollutants.

Hereinafter, further description will be made with reference to the Examples.

### Example 1

Example 1 provides a preparation method for a carbon monoxide catalyst, including the following steps:

### (1) Preparation of Catalytic Particles

### 1) Preparation of a First Powder:

\textcircled{1} pretreatment of a first titanium dioxide: an appropriate amount of TiO₂ was weighed into a porcelain boat, and was subjected to pretreatment by roasting by using a muffle furnace in an air atmosphere at a heating rate of 3 C°/min at 700 C° for 4 h, and the resulting TiO₂ was denoted as TiO₂ (700° C.).

\textcircled{2} Preparation of a first noble metal salt solution: platinum nitrate and palladium nitrate were selected as a first noble metal salt, and a first noble metal salt solution with a concentration of 10 g/L was prepared.

\textcircled{3} Preparation of a cerium nitrate solution: 18.1 g of cerium nitrate was weighed and dissolved in deionized water to be prepared into a 0.5 mol/L solution ready for use.

\textcircled{4} Preparation of a first titanium dioxide suspension: 1200 g of pre-treated first titanium dioxide was weighed into a beaker, 2400 ml of deionized water was added, and stirring was performed to form a uniform suspension.

\textcircled{5}) First mixing: the first titanium dioxide suspension was heated in a water bath to 60° C.; the prepared cerium nitrate solution was then added dropwise to the first titanium dioxide suspension, and after stirring for 10 min, the prepared first noble metal salt solution was added dropwise to the suspension according to a ratio according to a mass fraction of Pt in a final catalyst was 0.7% to obtain a first mixed solution.

\textcircled{6} After the first mixed solution was continued to be stirred for 5 h, the first mixed solution was dried in an air blast drying oven at 120° C. for 12 h. The dried material was then placed in an agate mortar to be carefully ground into a powder. The powder was then placed in a muffle furnace to be heated to 500° C. at a heating rate of 3° C./min in an air atmosphere. After roasting for 2 h, cooling was performed to room temperature to obtain the first powder.

### 2) Preparation of a Second Powder:

\textcircled{1} Preparation of a cobalt acetate solution (a first cobalt salt solution): 1.8 g of cobalt acetate was weighed into a beaker, 4000 ml of absolute ethanol was added to the weighed cobalt acetate, and stirring was continued to be performed for 10 min under heating in a water bath. 3000 ml of deionized water was added to the beaker, heating was performed to 60° C. in the water bath, and stirring was continued to be performed for 30 min to obtain the cobalt acetate solution.

\textcircled{2} Preparation of an ammonium molybdate solution (a first metal ammonium salt solution): ammonium molybdate was mixed with water to obtain the ammonium molybdate solution.

\textcircled{3} Preparation of a sodium carbonate solution (a first carbonate solution): 689 g of sodium carbonate was weighed and dissolved in 6500 ml of ionized water by using a beaker, then the solution was transferred to a volumetric flask, the beaker was washed for 3 times, the obtained liquid was also transferred to the volumetric flask, and finally the volume in the volumetric flask was made up, and the prepared 1 mol/L sodium carbonate solution was ready for use.

\textcircled{4}) Second mixing: the ammonium molybdate solution was added to the cobalt acetate solution, and stirring was continued to be performed for 30 min after heating at 60 C° in a water bath; the sodium carbonate solution was then slowly added dropwise to the cobalt acetate solution, and a pH value of a suspension was measured, and when the pH value reached 10, the dropwise addition of the sodium carbonate solution was stopped to obtain a second mixed solution.

\textcircled{5}) After the second mixed solution was continued to be stirred for 3 h, the second mixed solution was allowed to stand for aging for 2 h, and the suspension was subjected to suction filtration and washed to be neutral; the washed paste was put in a drying oven at 120° C. to be dried for 10 h; after being sufficiently dried, the dried material was placed in a muffle furnace to be heated to 400° C. at a heating rate of 3° C. min in an air atmosphere, and after roasting for 3 h, cooling was performed to room temperature to obtain the second powder.

### 3) Preparation of the Catalytic Particles

After the first powder and the second powder were mixed in a mass ratio of 6:1, the obtained mixture was placed in a ball milling tank, an appropriate amount of deionized water was added, and uniform stirring was performed to obtain a mixture; and
the mixture was ball milled clockwise for 60 min and counterclockwise for 60 min by using a ball mill at a rotation speed of 400 r/min. After the end of the ball milling, the ball milled material was taken out, dried sufficiently, dried at 120° C. for 12 h, roasted at 400° C. for 2 h by using a muffle furnace, and then ground and sieved through a sieve to obtain particles of 20-40 meshes, which are the catalytic particles.
   (2) the Catalytic Particles were Mixed with Water to Obtain an Aqueous Catalytic Particle solution.

### (3) Preparation of a First Supported Slurry:

\textcircled{1} Preparation of a first thickener solution: 13 g of carboxymethyl cellulose and 130 g of deionized water were weighed, and the carboxymethyl cellulose and the water were mixed to obtain the first thickener solution with a mass fraction of 10%.

\textcircled{2}) Preparation of a first dispersant solution: 15.6 g of polyvinyl alcohol powder and 156 g of deionized water were weighed, and the polyvinyl alcohol and the water were mixed to obtain the first dispersant solution having a mass fraction of 10%.

\textcircled{3} First, 2450 g of ionized water was poured into a mixing tank, a mixer was turned on, and after stirring for 5 min, 1300 g of a binder solution was slowly added, and stirring was continued to be performed for 10 min, 1170 g of the prepared aqueous catalytic particle solution was weighed and slowly poured into the mixing tank, and the prepared first dispersant solution and the prepared first thickener solution were sequentially poured into the mixing tank, and stirring was performed for 30 min each time. A pH of a slurry was adjusted to be 6 with ammonia water, and stirring was performed at room temperature for 6 h. The state of the slurry was observed at all times, and after stirring, the first supported slurry with high solid content, good fluidity, and stable viscosity was obtained.

### (4) Preparation of the Carbon Monoxide Catalyst

1) Pretreatment of a first support: cordierite was selected as the first support, was washed with distilled water and then placed in acetic acid at a concentration of 10%, sealing was performed with a lid, and then the first support was soaked for 3 h while heating at a constant temperature of 80° C. After the soaked first support was taken out, the soaked first support was dried at room temperature for 2 h, and dried at 80° C. for 6 h, the dried first support was roasted at 400° C. for 2 h in a muffle furnace, and cooling was performed to room temperature to obtain the pretreated cordierite.

2) Coating: the first supported slurry was placed in a slurry storage tank, the pretreated cordierite was weighed and placed in a coating device, a purge pressure of the coating device was set to be 0.4 MPa, the slurry intactly and uniformly coated an inner wall, and excess slurry was blown down into a slurry recovery tank. (The supporting amount of the catalytic particles on a honeycomb support (dry basis) is 100-150 kg/m³, and components are uniformly supported in the direction of a pore channel).

3) Drying and roasting: the coated cordierite was dried in an oven at 120° C. for 12 h, wherein it was required that the coated cordierite was thoroughly dried, the dewatering rate reached 90%, and there was no crack and no peeling after drying;

After drying, roasting was performed in a muffle furnace, wherein heating was performed at a heating rate of 2° C./min to 350° C., the temperature was maintained for 2 h, and cooling was started to be performed. After roasting, slow cooling was performed to room temperature to obtain the carbon monoxide catalyst.

### Example 2

A preparation method for a carbon monoxide catalyst provided in Example 2 had basically the same steps as those in Example 1, except that:
glass fiber was selected as the first support.

### Example 3

A preparation method for a carbon monoxide catalyst provided in Example 3 had basically the same steps as those in Example 1, except that:
the first supported slurry was adjusted by using citric acid so that a pH was 4.

### Example 4

A preparation method for a carbon monoxide catalyst provided in Example 4 had basically the same steps as those in Example 1, except that:
the first supported slurry was adjusted by using citric acid so that a pH was 5.5.

### Example 5

A preparation method for a carbon monoxide catalyst provided in Example 5 had basically the same steps as those in Example 1, except that:
the first supported slurry was adjusted by using ammonia water so that a pH was 7.5.

### Example 6

A preparation method for a carbon monoxide catalyst provided in Example 6 had basically the same steps as those in Example 1, except that:
the first supported slurry was adjusted by using ammonia water so that a pH was 9.

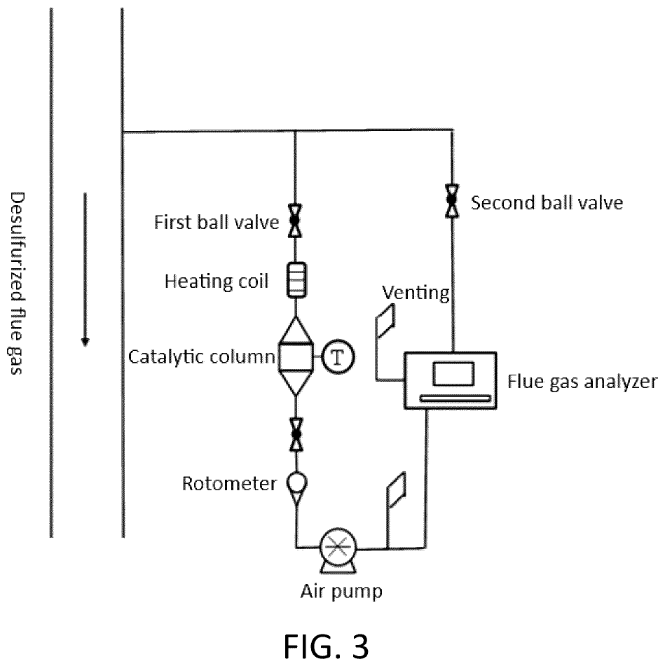

In order to verify the advancement of the examples of the present disclosure, the carbon monoxide catalysts prepared in Examples 1-6 and the existing copper-manganese based catalyst and the existing iron-magnesium-cobalt catalyst were selected to respectively carry out catalytic experiments on carbon monoxide in industrial flue gas. An experimental device used is shown in FIG. 3, and the experimental conditions of 260° C. and a space velocity of 17000 h⁻¹ were adopted.

As shown in FIG. 3, an air path is led out from a desulfurized flue gas pipeline, a power of which is provided by an air pump, a flow rate of which is controlled by a rotameter, and the temperature of which is controlled by a heating coil. A first ball valve is opened and a second ball valve is closed, so that the vented gas enters a catalytic column through a pipeline, and the temperature of the catalytic column is 200-220° C. The catalytic column is filled with the carbon monoxide catalyst prepared in Example 1 or the existing copper-manganese-based catalyst or the existing iron-magnesium-cobalt catalyst to catalytically oxidize carbon monoxide in the vented gas to carbon dioxide to obtain a treated gas.

During the measurement, a gas treated by a monolithic carbon monoxide catalyst is introduced into a flue gas analyzer, and the content of carbon monoxide in the treated gas is measured, and the carbon monoxide content is recorded after a reading of the flue gas analyzer is stable, and then the gas is vented.

The first ball valve is closed and the second ball valve is opened, so that the vented gas directly enters the flue gas analyzer, and the carbon monoxide content of the vented gas is measured, and the carbon monoxide content is recorded after a reading of the flue gas analyzer is stable. The catalytic efficiency of the carbon monoxide catalyst is finally calculated from the carbon monoxide content of the flue gas before treatment and the carbon monoxide content of the treated gas.

The comparison of the experimental results of the carbon monoxide catalyst in Example 1 and the existing copper-manganese-based catalyst and the existing iron-magnesium-cobalt catalyst is shown in Table 1 below.

TABLE 1

| | | Copper- | Iron- |
|---|---|---|---|
| | Example | manganese- | magnesium- |
| Item | 1 | based catalyst | cobalt catalyst |
| Average removal rate of | 90% | 83% | 76% |
| CO (purification | | | |
| efficiency of flue gas) | | | |
| Deactivation rate (sulfur | 2.3% | 8.2% | 9.1% |
| resistance and water | | | |
| resistance) | | | |
| Agglomerated or not | No | Yes | Yes |

As can be seen from the above Table 1, the carbon monoxide catalyst prepared by the preparation method in Example 1 of the present disclosure has high catalytic efficiency for carbon monoxide and a low deactivation rate, and no agglomeration or a small amount of negligible agglomeration occurs during the catalytic process.

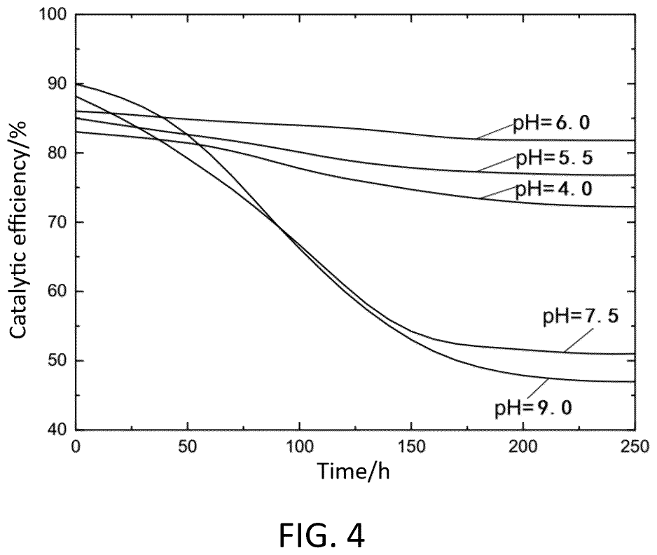

During preparation, the effect of the pH of the first supported slurry on the catalysis of the carbon monoxide catalyst is shown in FIG. 4 of the description, as can be seen from FIG. 4, the pH of the first supported slurry has a direct effect on the catalytic performance of the finally obtained carbon monoxide catalyst, and when the pH of the first supported slurry is 6, the catalytic efficiency of the prepared carbon monoxide catalyst is the most stable, which is due to the fact that in the carbon monoxide catalyst obtained by supporting the first supported slurry at this pH, the supporting amount of noble metals and other metals in the support is high, and there are relatively many active sites, and the high supporting amount of other metals results in high sulfur resistance and water resistance of the carbon monoxide catalyst, resulting in high catalytic stability of the carbon monoxide catalyst in sintering flue gas purification. The carbon monoxide catalyst has high activity and an applicable temperature range, and catalytic oxidation starts at 120° C. and the catalytic efficiency at 220° C. can reach 90% or more.

### Example 7

Example 7 proposes a preparation method for a carbon monoxide catalyst, including the following steps:

### (1) Preparation of a Second Supported Slurry

### 1) Preparation of a Third Mixed Solution

\textcircled{1} Preparation of a second noble metal salt solution: 5 g of a noble metal was selected and prepared into a 10 g/L noble metal solution in a 500 mL volumetric flask for later use.

\textcircled{2} Pretreatment of a second titanium dioxide: heating was performed to 700-800 C° at a heating rate of 5-10 C°/min in an air atmosphere, and roasting was performed for 3-4 h to obtain the pretreated second titanium dioxide.

\textcircled{3} Preparation of a second titanium dioxide suspension: the pretreated second titanium dioxide and water were mixed and stirred to obtain the second titanium dioxide suspension.

\textcircled{4} Fourth mixing: the second titanium dioxide suspension was stirred at a temperature of 40 C° for 30 min while adding dropwise the second noble metal salt solution, and stirring was continued to be performed for 30-35 min to obtain the third mixed solution.

### 2) Preparation of a Fourth Mixed Solution

\textcircled{1} Preparation of a cobalt acetate solution: 700 g of cobalt acetate was weighed and dissolved in a 50% ethanol solution, and stirring was performed in water at 60 C° for 10 min to obtain the cobalt acetate solution.

\textcircled{2} Preparation of an ammonium molybdate solution: 140 g of ammonium molybdate was weighed and mixed with water, and uniform stirring was performed at 60 C° in a water bath for 30 min to obtain the ammonium molybdate solution.

\textcircled{3} Fifth mixing: a second metal ammonium salt solution and a second cobalt salt solution were mixed under the stirring condition in a water bath at a temperature of 60-65 C° to obtain the fourth mixed solution.

### 3) Preparation of a Fifth Mixed Solution: Ammonia Water was Slowly Added to the Fourth Mixed Solution, and its pH Value was Detected to be 10-12, and a Suspension was Continued to be Stirred for 30 Min to Obtain the Fifth Mixed Solution.

4) Preparation of a Sixth Mixed Solution: The Third Mixed Solution and the Fifth Mixed Solution were Uniformly Mixed in a Mass Ratio of 1:1 to Obtain the Sixth Mixed Solution.

### 5) Preparation of the Second Supported Slurry

\textcircled{1} Preparation of a second dispersant solution: 20 g of polyvinyl alcohol powder and 180 g of deionized water were weighed, and the polyvinyl alcohol powder and the deionized water were mixed to obtain the second dispersant solution with a mass fraction of 10%.

\textcircled{2} Preparation of a second binder solution: 20 g of sodium silicate and 180 g of deionized water were weighed, sodium silicate and the deionized water were mixed, and stirring was performed for at least 30 min to prepare the second binder solution having a mass fraction of 10%.

\textcircled{3} Preparation of a second thickener solution: 20 g of carboxymethyl cellulose and 180 g of deionized water were weighed, and the carboxymethyl cellulose and the deionized water were mixed to obtain the second thickener solution having a mass fraction of 10%.

\textcircled{4}) First, 2400 g of ionized water was poured into a mixing tank, a mixer was turned on, and after stirring for 5 min, 1300 g of the second binder solution was slowly added, and stirring was continued to be performed for 10 min, 1170 g of the prepared sixth mixed solution was weighed and slowly poured into the mixing tank, and the prepared second dispersant solution and the prepared second thickener solution were sequentially poured into the mixing tank, and stirring was performed for 30 min each time. A pH of a slurry was adjusted to be 6 with ammonia water, and stirring was performed at room temperature for 6 h. The state of the slurry was observed at all times and after stirring, the second supported slurry with high solid content, good fluidity and stable viscosity was obtained.

### (2) Preparation of the Carbon Monoxide Catalyst

1) Pretreatment of a second support: glass fiber of 150 mm×150 mm×150 mm was selected, and roasted at 400° C. in a muffle furnace for 2 h, and cooling was performed to room temperature to obtain a pretreated second support.

2) Coating: the second supported slurry was placed in a slurry storage tank, the pretreated glass fiber was weighed and placed in a coating device, a purge pressure of the coating device was set to be 0.35 MPa, the slurry intactly and uniformly coated an inner wall, and excess slurry was blown down into a slurry recovery tank. (The supporting amount of catalytic particles on the glass fiber (dry basis) is 100-150 kg/m³, and components are uniformly supported in the direction of a pore channel.)

3) Drying and roasting: the coated glass fiber was dried in an oven at 120° C. for 12 h, wherein it was required that the coated glass fiber was thoroughly dried, the dewatering rate reached 90%, and there was no crack and no peeling after drying;

After drying, roasting was performed in a muffle furnace, wherein heating was performed at a heating rate of 2° C./min to 350° C., the temperature was maintained for 2 h, and cooling was started to be performed. After roasting, slow cooling was performed to room temperature to obtain the carbon monoxide catalyst.

### Example 8

A preparation method for a carbon monoxide catalyst provided in Example 8 had basically the same steps as those in Example 7, except that:
the second supported slurry was adjusted by using citric acid so that a pH was 4.

### Example 9

A preparation method for a carbon monoxide catalyst provided in Example 9 had basically the same steps as those in Example 7, except that:
the second supported slurry was adjusted by using citric acid so that a pH was 5.5.

### Example 10

A preparation method for a carbon monoxide catalyst provided in Example 10 had basically the same steps as those in Example 7, except that:
the second supported slurry was adjusted by using ammonia water so that a pH was 7.5.

### Example 11

A preparation method for a carbon monoxide catalyst provided in Example 11 had basically the same steps as those in Example 7, except that:
the second supported slurry was adjusted by using ammonia water so that a pH was 9.

In order to verify the advancement of the examples of the present disclosure, the carbon monoxide catalysts prepared in Examples 7-11 and the existing Hopcalite catalyst and the existing iron-magnesium-cobalt catalyst were used to respectively carry out catalytic experiments on carbon monoxide in industrial flue gas. The steps of the catalytic experiments on carbon monoxide were the same as those using the carbon monoxide catalyst prepared by the first preparation method for the carbon monoxide catalyst. A molar ratio of copper to manganese in the Hopcalite catalyst is (2.2-3):1.

The comparison of the experimental results of the carbon monoxide catalyst in Example 7 and the existing Hopcalite catalyst and the existing iron-magnesium-cobalt catalyst is shown in Table 2 below.

TABLE 2

| | Example | Hopcalite | Iron-magnesium- |
|---|---|---|---|
| | 7 | catalyst | cobalt catalyst |
| Average removal rate of | 91% | 83% | 76% |
| CO (purification | | | |
| efficiency of flue gas) | | | |
| Deactivation rate (sulfur | 2.2% | 8.2% | 9.1% |
| resistance and water | | | |
| resistance) | | | |
| Agglomerated or not | No | Yes | Yes |

As can be seen from the above Table 2, the carbon monoxide catalyst prepared by the preparation method in Example 7 of the present disclosure has high catalytic efficiency for carbon monoxide and a low deactivation rate, and no agglomeration or a small amount of negligible agglomeration occurs during the catalytic process.

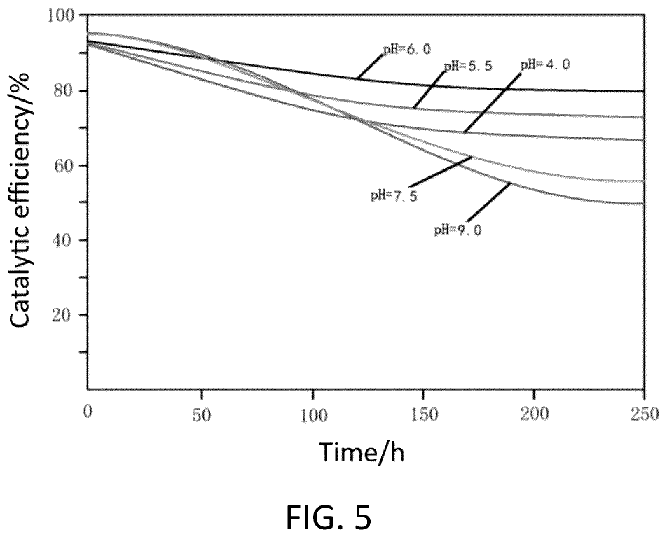

During preparation, the effect of the pH of the second supported slurry on the catalysis of the carbon monoxide catalyst is shown in FIG. 5 of the description, as can be seen from FIG. 5, the pH of the second supported slurry has a direct effect on the catalytic performance of the finally obtained carbon monoxide catalyst, and when the pH of the second supported slurry is 6.0, the catalytic efficiency of the prepared carbon monoxide catalyst is the most stable, which is due to the fact that in the carbon monoxide catalyst obtained by supporting the second supported slurry at this pH, the supporting amount of noble metals and other metals in the support is high, active sites are correspondingly high, and the high supporting amount of other metals results in high sulfur resistance and water resistance of the carbon monoxide catalyst, resulting in high catalytic stability of the carbon monoxide catalyst in sintering flue gas purification. The carbon monoxide catalyst has high activity and an applicable temperature range, and catalytic oxidation starts at 120° C. and the catalytic efficiency at 220° C. can reach 90% or more.

The above are only preferred examples of the carbon monoxide catalyst and the preparation method therefor and use thereof according to the present disclosure, and are not intended to limit the present disclosure, and any modifications, equivalent replacements, improvements, and the like made within the spirit and principle of the present disclosure should be included within the protection scope of the present disclosure

What is claimed is:

1. A carbon monoxide catalyst, comprising a support and metal catalytic particles or comprising the metal catalytic particles and metal oxide catalytic particles supported in the support, wherein
metals in the metal catalytic particles or the metal oxide catalytic particles comprise a noble metal, titanium, cerium, cobalt, nickel and molybdenum;
the support comprises one or more of cordierite, honeycomb ceramic, glass fiber, a porous carbon material, or a hierarchical porous carbon material; and
the carbon monoxide catalyst comprises the following metal elements in percentage by mass: 0.5-1.0% the noble metal, 0.5-1.0% the titanium, 0.5-1.0% the cerium, 0.5-1.0% the cobalt, 0.5-1.0% the nickel, and 0.5-1.0% the molybdenum.

2. The carbon monoxide catalyst according to claim 1, wherein at least one of:
a supporting amount of the metal catalytic particles is 90-150 kg/m³;
the carbon monoxide catalyst has a particle size in a range of 50-200 nm;
a supporting amount of the metal oxide catalytic particles is 90-150 kg/m³;
the metal catalytic particles have a particle size in a range of 1-100 nm;
the metal oxide catalytic particles have a particle size in a range of 1-100 nm; or
the metal catalytic particles have a mesh size of 20-40 meshes.

3. The carbon monoxide catalyst according to claim 1, wherein the noble metal comprises one or more of gold, silver, ruthenium, rhodium, palladium, osmium, iridium, or platinum.

4. A preparation method for the carbon monoxide catalyst according to claim 3, wherein the preparation method comprises steps of:
preparing a first powder by using a first noble metal salt solution, a cerium nitrate solution, and a first titanium dioxide suspension;
preparing a second powder by using a first cobalt salt solution, a first metal ammonium salt solution, and a first carbonate solution;
preparing an aqueous catalytic particle solution by using the first powder and the second powder; and
preparing the carbon monoxide catalyst by using the aqueous catalytic particle solution, a first binder solution, a first thickener solution, a first dispersant solution, and a water retaining agent.

5. The preparation method for the carbon monoxide catalyst according to claim 4, wherein at least one of:
the step of preparing the first powder comprises: subjecting the first noble metal salt solution, the cerium nitrate solution and the first titanium dioxide suspension to first mixing to obtain a first mixed solution; and subjecting the first mixed solution to first drying and first roasting to obtain the first powder;
the step of preparing the second powder comprises: subjecting the first cobalt salt solution, the first metal ammonium salt solution and the first carbonate solution to second mixing to obtain a second mixed solution; and subjecting the second mixed solution to second drying and second roasting to obtain the second powder;
the step of preparing the aqueous catalytic particle solution comprises: mixing the first powder with the second powder, performing first ball milling, performing third drying, performing third roasting, and performing grinding and sieving to obtain catalytic particles; and mixing the catalytic particles with water to obtain the aqueous catalytic particle solution; or
the step of preparing the carbon monoxide catalyst comprises: performing third mixing by using the aqueous catalytic particle solution, the first binder solution, the first thickener solution, the first dispersant solution and the water retaining agent to obtain a first supported slurry; and subjecting the first supported slurry to first supporting with a first support, and performing fourth roasting to obtain the carbon monoxide catalyst.

6. The preparation method for the carbon monoxide catalyst according to claim 5, wherein at least one of:
metal elements in the catalytic particles comprise: a noble metal element, a cerium element and a titanium element;
a noble metal salt in the first noble metal salt solution comprises one or more of a nitrate, chlorate, or chloride of gold, silver, ruthenium, rhodium, palladium, osmium, iridium, and platinum;
the noble metal salt in the first noble metal salt solution has a concentration of 10-15 g/L;
the cerium nitrate solution has a molar concentration of 0.5-1.0 mol/L;
a content of titanium dioxide in the first titanium dioxide suspension is 500-800 g/L;
a concentration of cobalt ions in the first cobalt salt solution is 0.02-0.10 g/L;
a mass fraction of a first metal ammonium salt in the first metal ammonium salt solution is 0.1-0.5%;
the first carbonate solution has a concentration of 1-1.5 mol/L;
a mass ratio of the catalytic particles to the water in the aqueous catalytic particle solution is 1:(0.3-3);
in the first ball milling, milling balls have a particle size of not higher than 1 mm;
in the first ball milling, the milling balls comprise at least one of zirconia balls, alumina balls, or agate balls;
the first ball milling is performed at a temperature of 25-30° C.;
a mass fraction of a first binder in the first binder solution is 1-15%;
a mass fraction of a first thickener in the first thickener solution is 1-20%; or
a mass fraction of a first dispersant in the first dispersant solution is 1-20%.

7. The preparation method for the carbon monoxide catalyst according to claim 5, wherein at least one of:
the step of the third mixing comprises: fourth mixing and stirring the first binder solution and the first dispersant solution in a specified ratio, adding the aqueous catalytic particle solution, performing stirring, adding the first thickener solution and the water retaining agent, performing stirring, and finally adjusting a pH to be 4-10 to obtain the first supported slurry; or
the step of the fourth roasting comprises: drying a slurry obtained after the first supporting at 90-110° C. for 12-14 h until a dewatering rate of the slurry is not less than 90%, performing heating to 350-400° C. at a heating rate of 2-32° C./min, and performing roasting for 1.5-2 h to obtain the carbon monoxide catalyst.

8. The preparation method for the carbon monoxide catalyst according to claim 5, wherein at least one of:
the first cobalt salt solution comprises an organic acid cobalt salt solution;
a first metal ammonium salt in the first metal ammonium salt solution comprises one or more of ammonium molybdate, ammonium tungstate, or ammonium metavanadate;
metal elements in the catalytic particles comprise: at least one of a molybdenum element, a tungsten element, or a vanadium element; or
a carbonate in the first carbonate solution comprises one or more of sodium carbonate, potassium carbonate, or lithium carbonate.

9. The preparation method for the carbon monoxide catalyst according to claim 5, wherein at least one of:
a mass ratio of the first powder to the second powder is 6:(1-2); or
a mass ratio of the aqueous catalytic particle solution to the first binder solution to the first thickener solution to the first dispersant solution to the water retaining agent is (1-5):(0.5-4):(0.5-3):(0.5-2):1.

10. Use of the carbon monoxide catalyst according to claim 1 in a field of removing carbon monoxide pollutants.
